(19) United States
(12) Patent Application Publication
(10) Pub. No.: US 2006/0294050 A1
(43) Pub. Date: Dec. 28, 2006

(54) Retrieving server-based help content

(75) Inventors: Justin Shane McRoberts, Seattle, WA (US); Wenlong Dong, Redmond, WA (US); Dale E. Rogerson, Seattle, WA (US); Praful Pratap Chavda, Redmond, WA (US); Sridhar Chandrashekar, Redmond, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Redmond, WA (US)

(21) Appl. No.: 11/168,115

(22) Filed: Jun. 28, 2005

(51) Int. Cl. G06F 17/30

(52) U.S. Cl. 707/1

(57) ABSTRACT

A URI is received and includes an indication of an item of content. A determination is made as to whether there is access to a help server. If there is access, then a version of the item of content is retrieved from the help server. If there is no access, then a version of the item of content is retrieved from a local client content store.

### BACKGROUND

The material in this section is merely provided for general background information and is not intended for use as an aid in determining the scope of the claimed subject matter. Further, it should also be emphasized that the claimed subject matter is not limited to implementations that solve any or all of the disadvantages of currently known systems noted in this section.

Many help systems are configured to display only locally installed help content. That being said, some server-based help systems are configured to provide updated help to end-users. In these systems, however, the local help system and the remote help system are generally isolated from one another. In many cases, the way that fresh client side content is made available to users is through application of an update mechanism configured to obtain information from a remote source to update a local content store. This update scheme suffers from several disadvantages including 1) client side help systems are not always equipped to handle updates; 2) a limited number of end users may actually take advantage of the update mechanism; and 3) updating may not occur very frequently.

### SUMMARY

This Summary is provided to introduce in a simplified form a selection of concepts that are further described below in the Detailed Description. This Summary is not intended to identify key features or essential features of the claimed subject matter, nor is it intended for use as an aid in determining the scope of the claimed subject matter.

A URI is received and includes an indication of an item of content. A determination is made as to whether there is access to a help server. If there is access, then a version of the item of content is retrieved from the help server. If there is no access, then a version of the item of content is retrieved from a local client content store.

### BRIEF DESCRIPTION OF THE DRAWINGS

FIG. 1 is a block diagram of one computing environment.

FIG. 2 is a schematic diagram of an information retrieval system.

FIG. 3 is a schematic diagram demonstrating a system for delivering help content.

### DETAILED DESCRIPTION

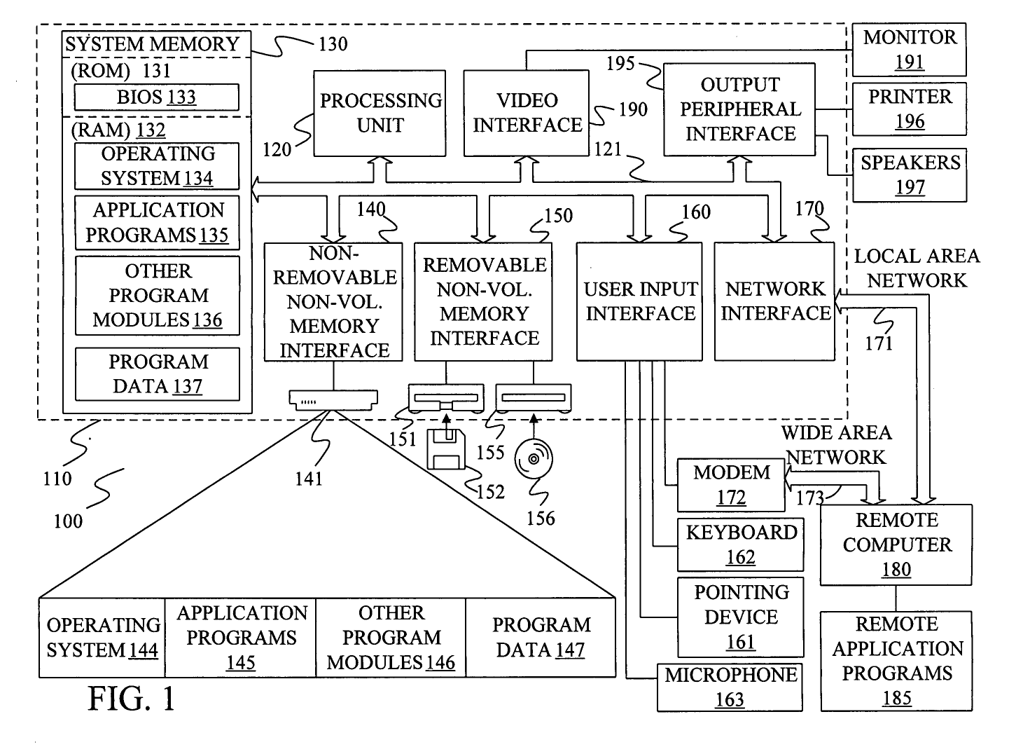

FIG. 1 illustrates an example of one applicable computing environment 100. The computing environment 100 is only one example of an applicable computing environment and is not intended to suggest any limitation as to scope of use or functionality. Neither should computing environment 100 be interpreted as having any dependency or requirement relating to any one or combination of illustrated components.

Other applicable environments include numerous other general purpose or special purpose computing systems or configurations. Examples include, but are not limited to, personal computers, server computers, hand-held or laptop devices, multiprocessor systems, microprocessor-based systems, set top boxes, programmable consumer electronics, network PCs, minicomputers, mainframe computers, telephony systems, and distributed computing environments that include any of the above systems or devices, and the like.

Embodiments of the invention may be described in the general context of computer-executable instructions, such as program modules, to be executed by a computer. Generally, program modules include routines, programs, objects, components, data structures, etc. that perform particular tasks or implement particular abstract data types. Embodiments may also be practiced in distributed computing environments where tasks are performed by remote processing devices that are linked through a communications network. In a distributed computing environment, program modules may be located in both local and remote computer storage media including memory storage devices.

With reference to FIG. 1, the environment 100 includes a general-purpose computing device in the form of a computer 110. Components of computer 110 may include, but are not limited to, a central processing unit 120, a system memory 130, and a system bus 121 that couples various system components including the system memory to the processing unit 120.

The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user-input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

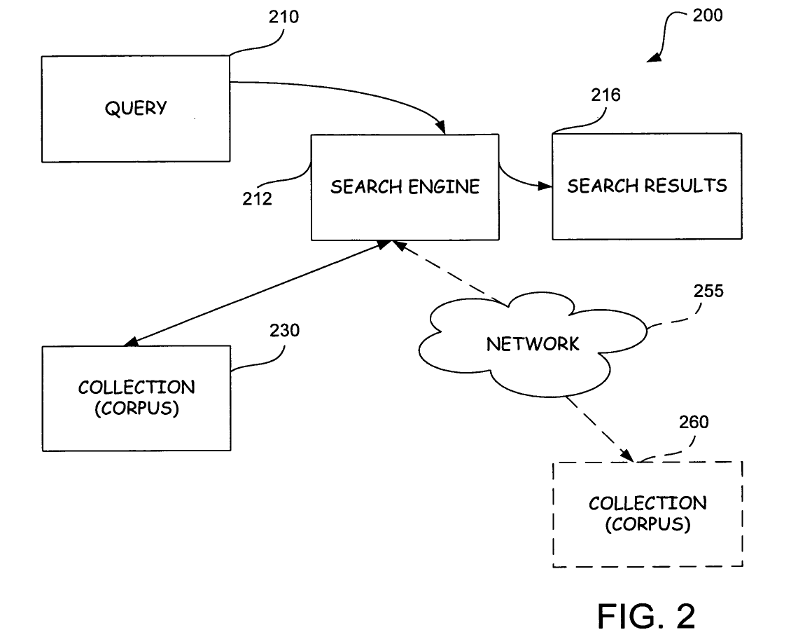

FIG. 2 is a schematic block diagram of an information retrieval system 200. A query 210 containing a user's search terms is entered into a search engine 212. Search engine 212 processes input query 210, and then applies the search terms to an available document collection or corpus 230 by searching for the terms in documents that correspond to input query 210. Documents that qualify to be considered matching (or at least an indication of such documents) are returned to search engine 212. Corresponding search results 216 are provided to the user.

In one embodiment, information retrieval system 200 is implemented as a client-side searching tool, and query 210 is a ‘help query’ submitted by the user of a software application. The help query 210 is submitted to search engine 212. A plurality of help documents (collection 230) is then searched to determine which documents (result set 216) may be most useful to facilitate completion of a task reflected in the terms of the query.

Search engine 212 is further configured to access a second collection or corpus 260 through a network 255. Corpus 260 is remotely maintained on a server, such as a help content server. Collection 260 illustratively includes some content that is more fresh or up-to-date than that associated with collection 230. In one embodiment, search engine 212 is configured to process query 210 against either of the collections 230 and 260. A determination is made as to which content collection, remote or local, search results 216 should be based upon. That determination is described in more detail below.

It should be noted that, even though examples may be provided in the context of a help query system, the present invention is not so limited. A help query system provides an easy-to-understand example model of a client-side search environment and is thus utilized within the present description to illustrate related points and features. As those skilled in the art will appreciate, however, embodiments could just as easily be applied in a different context without departing from the scope of the present invention.

It is also worth mentioning that, for the purpose of the present description, the term “query” is utilized to designate a particular search input such as, but not necessarily limited to, a particular search term or set of search terms. The term “asset” is utilized to represent a designation of a document or some other item of content. For example, a help query in the form of “how to make my computer run faster” may correspond to the asset “How To Defragment Your Hard Drive,” which is illustratively a unique designation or title of a help document.

An assumption behind certain embodiments of the present invention is that user satisfaction is improved by providing fresh, updated help content when the user is connected. It should be noted that “connected” and “disconnected”, in the context of the present description, refer to the existence or non-existence of an active communication link to a help server through a network such as, but not limited to, the Internet. In one embodiment, a seamless and consistent user experience is provided by automatically converting requests for client help topics to corresponding server requests in connected scenarios, the response from the server then being presented to the user through the client system. Thus, an embodiment pertains to an integrated help solution that works seamlessly across disconnected and connected states.

Ubiquitous client URIs (Uniform Resource Indicators) are illustratively utilized to identify client and server help topics. A URI is resolved such that a local client version is obtained if the computer is not connected, and a server-based version is obtained if the computer is connected. In one embodiment, regardless of the source of the retrieved content, the user experience is essentially the same. The described system simplifies the process of updating content and eliminates reliance on a separate update mechanism to facilitate delivery of fresh, updated content to end users.

A few additional terminology issues will now be addressed. A “help topic,” as that and similar terminology is utilized within the present description, is comprised of one or more assets. There are at least two types of assets: task and resource. A task is the main page (likely to be characterized in XML format) that contains the major structure of a help topic. A resource is a piece of data that enriches different aspects of a help topic. For example, a resource can be a jpg/gif image, a css stylesheet, an XML segment, or any other data file.

In application, an “asset” or a “help topic” can take any of a variety of forms. For example either one of these terms may represent a data file, such as an XML file. However, the term could just as easily represent a numerical representation (e.g., a GUID) indicative of executable code (e.g., a task). Those skilled in the art will appreciate that other alternatives are also within the scope of the present invention.

In one embodiment, a data management scheme is provided so as to support a unique identification of an asset anywhere. Assets are illustratively grouped into different functional collections called “ContentSets.” The name of a ContentSet illustratively includes a dotted format in order to discourage naming conflict. Each content set may conform to a standard format such as: <company>.<product>.<component>. For example, the string “Microsoft.Office.Word” follows this convention.

Within each ContentSet, a unique identifier called an AssetID is defined for each asset. In one embodiment, this is achieved by combining a human friendly name plus a globally unique identifier (GUID). For example, “Word.Overview.Task.87990c05-5880-408d-85cb-5376e8ba498c” is illustratively an assetID. The described two-level content organization scheme provides a unique way to identify an asset from any machine and thus is effective for both client and server content.

In one embodiment, given the relevant AssetID and ContentSet, a URI can easily be generated for the corresponding asset. For example, a URI can be formed as follows:
help://help.Microsoft.com/?id=<AssetID>[&content set=<contentset name>]

A client side help system will typically be configured with information as to which ContentSet the system is running and which language is set as the default for the corresponding user interface. Given these items of information, for most client side assets, the ContentSet name is not a necessary component. Thus, in accordance with one embodiment, an example URI may actually be reduced to its AssetID. An example is as follows:
Help://help.Microsoft.com/?id=Word.Overview.Task .87990c05-5880-408d-85cb-5376e8ba498c

In accordance with an alternate embodiment of the present invention, assets are instead identified within the URI utilizing a file-based path. There are a few disadvantages associated with this alternate embodiment. For example, the format will depend on the physical storage of the asset, making it relatively unstable. Also, if the asset is stored within a database, there may be no physical path. Still further, content re-organization will easily break the link between the client and the server.

In one embodiment, a URI resolver is configured to take a help URI and retrieve the embedded AssetID. The resolver illustratively also retrieves the ContentSet and UI language information, for example, based on the running client context. With these items of information (AssetID, ContentSet, and language), an asset can be requested from either the client or the server content store.

The URI resolver is illustratively configured to detect the network connectivity of the client machine. When the machine is connected (e.g., to the Internet) and the help server is available, the URI resolver connects to the help service, generates a server request for the asset, and sends the request to the helper server in order to retrieve the metadata and the content for the asset. If the client machine is not connected or the help server is not available, the URI resolver is illustratively configured to generate a request to the local content retrieval module. The data is then obtained from the local content store.

In one embodiment, the URI resolution and content retrieval components are not dependent upon a front-end rendering system for help topics. However, a transparent content retrieval mechanism can be provided so that the rendering system will work seamlessly with both local and online help content.

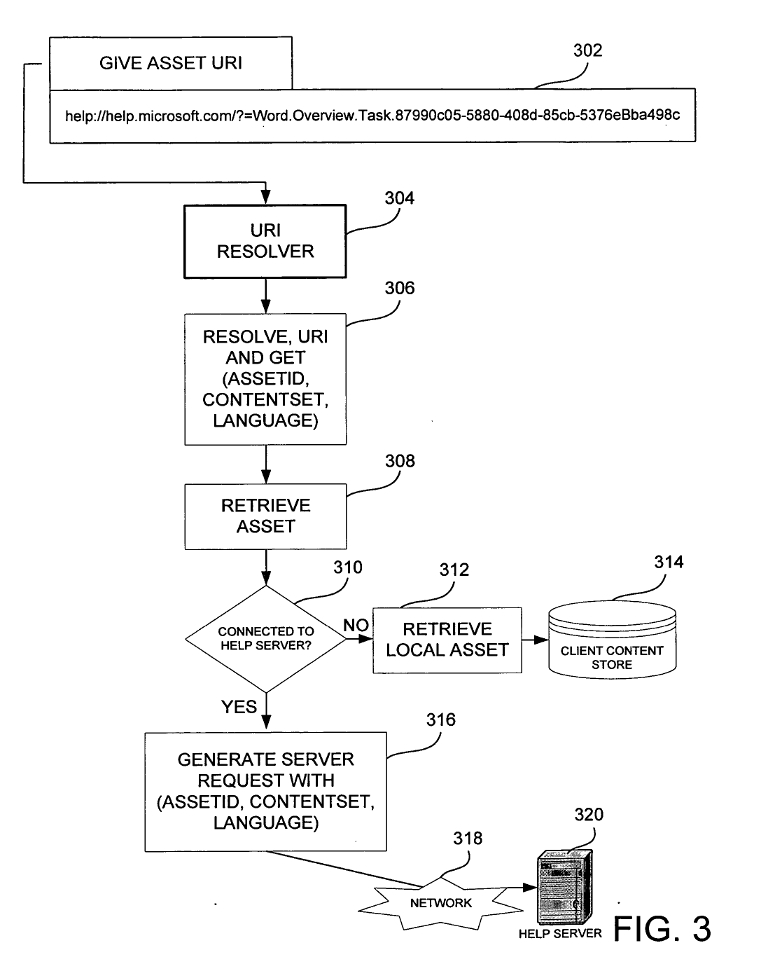

FIG. 3 is a schematic diagram demonstrating a system for delivering help content. A URI 302 is provided to a URI resolver 304. The URI 302 includes an indication of a help asset and, in one embodiment, is location-independent in accordance with the already described URI formation schemes. In accordance with block 306, URI 302 is resolved. An AssetID, a ContentSet and Language information are obtained. In accordance with one embodiment, one or more of these three items of information are derived from the content of URI 302 itself. In accordance with another embodiment, the ContentSet and/or Language information are derived from a running client context, as has been described.

In accordance with block 308, an asset is retrieved. The asset illustratively corresponds to the obtained AssetID. As is indicated by block 310, the asset comes from one of two different sources. If the client machine (i.e., the client machine from which the corresponding help request originates) does not have access to a help server 320, then the asset that is retrieved (block 312) from a client store 314. Client store 314 is illustratively a local database associated with the client machine.

If the client machine does have access to help server 320, then a server request is generated. The server request illustratively includes the AssetID, the ContentSet and/or the Language information. The request is sent across a network 318 (illustratively the Internet) to the help server 320. The asset content is sent back to the client in response to the server request.

It should again be emphasized that the scope of the present disclosure is not limited to the context of a help system. Similar concepts could just as easily be applied in other contexts, such as any system incorporating fresh content retrieval.

In one embodiment, the described fresh data retrieval concepts are broadly applied. For example, an asset can be represented as a link (e.g., a link inside a help document or within any UI system). When the link is invoked (e.g., “clicked on”) by the user, the described updates mechanism is invoked, based on the same instance of a URI, to retrieve local content from the client or remote content stored on a server depending on a status of connection.

In one embodiment, the described fresh data retrieval concepts are adapted to support versioning. Help content (or other content) is often related to a particular version of code. While a newer or fresher version of a particular piece of content may be available on a server, it may not be useful unless provided to a client that is equipped with the newer code. For example, suppose a user has a 2010 version of an operating system. Then, suppose that a service pack (SP1) for the 2010 operating system is published. While the help server may be equipped with new help content that corresponds to features in SP1, if SP1 is not installed on a given client, then it may not be desirable to provide new SP1 help content. Thus, in one embodiment, information about the context of the client system is also communicated to the server to support a determination as to what particular content should and should not be provided to a connected client, for example, based on client-side URIs as described herein.

Although the present invention has been described with reference to particular embodiments, workers skilled in the art will recognize that changes may be made in form and detail without departing from the spirit and scope of the invention.

What is claimed is:

1. A computer-implemented method for providing help content to a user, the method comprising:
receiving a URI that includes an indication of an item of content;
determining whether there is access to a help server;
if there is access, then retrieving a version of the item of content from the help server; and
if there is not access, then retrieving a version of the item of content from a local client content store.

2. The method of claim 1, wherein the version of the item of content from the help server is different than the version of the item of content from the local client content store.

3. The method of claim 1, wherein determining whether there is access comprises determining whether there is a connection to a network through which the help server is accessible.

4. The method of claim 1, wherein determining whether there is access comprises determining whether the help server is available.

5. The method of claim 1, wherein receiving a URI further comprises receiving a URI that includes a location-independent indication of an item of content.

6. The method of claim 1, wherein receiving a URI further comprises receiving a URI that includes a location-independent indication of a task asset.

7. The method of claim 1, wherein receiving a URI further comprises receiving a URI that includes a location-independent indication of a resource asset.

8. The method of claim 1, wherein retrieving a version of the item of content from the help server comprises generating a server request that includes at least one data component selected from a set consisting of an AssetID, a ContentSet, software version information and a language type.

9. The method of claim 1, wherein generating a server request comprises obtaining information indicative of a ContentSet based on a running client context.

10. The method of claim 1, wherein generating a server request comprises obtaining information indicative of a language type based on a running client context.

11. A system for providing help content to a user, the system comprising:
a client machine;
a client content store implemented so as to be accessible to the client machine;
a help server; and
a URI resolver configured to resolve a URI and obtain a corresponding item of content from either the client content store or the help server based on whether or not the client machine has access to the help server.

12. The system of claim 11, wherein the version of the corresponding item of content from the help server is different-than the version of the corresponding item of content from the client content store.

13. The system of claim 11, wherein determining whether or not the client machine has access comprises determining whether there is a connection to a network through which the help server is accessible.

14. The system of claim 11, wherein determining whether or not the client machine has access comprises determining whether the help server is available.

15. The system of claim 11, wherein said URI includes a location-independent indication of the corresponding item of content.

16. The system of claim 11, wherein said URI includes a location-independent indication of a task asset.

17. The system of claim 11, wherein said URI includes a location-independent indication of a resource asset.

18. The system of claim 11, wherein the URI resolver is further configured to, when the client machine does have access to the help server, generate a server request that includes at least one data component selected from a set consisting of an AssetID, a ContentSet, software version information and a language type.

19. A uniform resource indicator (URI) for supporting a system for delivering help content, the URI comprising a representation of a particular asset, the representation being simultaneously indicative of two different versions of the particular asset.

20. The URI of claim 19, wherein the representation of a particular asset is a location-independent representation.
